(19) United States
(12) Patent Application Publication
(10) Pub. No.: US 2014/0179369 A1
(43) Pub. Date: Jun. 26, 2014

(54) APPARATUS AND METHOD FOR PROVIDING PROXIMITY-BASED ZOOMING

(71) Applicant: NOKIA CORPORATION, Espoo (FI)

(72) Inventor: Allen Ming-kuang Han, Mountain View, CA (US)

(73) Assignee: NOKIA CORPORATION, Espoo (FI)

(21) Appl. No.: 13/721,669

(22) Filed: Dec. 20, 2012

(51) Int. Cl. H04N 5/225; H04M 1/02

(52) U.S. Cl. CPC H04N 5/225; H04M 1/0202
USPC 455/556.1

(57) ABSTRACT

An apparatus, method, and computer program product are described that provide for proximity-based zoom functionality for image capturing operations. A physical demarcation is presented to a user of a device, such as a reticle or a reference indication, by which the user can intuitively adjust a level of zoom to be applied in capturing an image. A position of the user with respect to the device is detected, such as by a sensor, and a representation of a scene capturable via the device is determined based on the position detected, where the representation corresponds to the user's view of the scene with respect to the physical demarcation.

### TECHNOLOGICAL FIELD

Embodiments of the present invention relate generally to facilitating zoom functionality for image capturing operations on mobile terminals.

### BACKGROUND

As mobile devices such as cell phones become more prevalent in society, such devices are also becoming more equipped to provide users with various types of functionality. From sophisticated communications features to image capturing capabilities, users are relying on their mobile devices to assist in most aspects of everyday life.

For examples, most mobile devices can be used to capture images, such as still photographs and videos. Users may be able to zoom in and zoom out on the subject whose image is being captured to capture images with varying levels of detail, as desired. In certain circumstances, however, the user may need to act fast to capture the desired image or may need to quickly switch from a wide shot to a close-up shot.

Accordingly, it may be desirable to provide a simple, intuitive, and user-measureable way for a user to zoom in and zoom out when using image capturing functionality on a mobile device.

### BRIEF SUMMARY OF EXAMPLE EMBODIMENTS

Accordingly, embodiments of an apparatus, method, and computer program product are described that provide proximity-based zoom functionality for image capturing operations in a user-measurable manner. In particular, embodiments of the invention provide a physical demarcation that a user can reference to determine the amount of zoom that will be effected when the mobile device is moved with respect to the user.

In particular, embodiments of an apparatus for providing proximity-based zoom functionality may include at least one processor and at least one memory including computer program code. The at least one memory and the computer program code may be configured to, with the processor, cause the apparatus to provide a physical demarcation to a user of a device, provide for detection of a position of the user with respect to the device, and determine a representation of a scene capturable via the device. The representation may be determined based on the position detected and may correspond to the user's view of the scene with respect to the physical demarcation.

In some cases, the physical demarcation may comprise a frame through which the scene is viewable. Additionally or alternatively, the physical demarcation may be provided via a display of the device. The at least one memory and the computer program code may be further configured to, with the processor, cause the apparatus to provide for detection of the position of the user with respect to the device by determining a proximity of the user to the device and/or by determining an angle of the user with respect to the device.

In some embodiments, the at least one memory and the computer program code may be further configured to, with the processor, cause the apparatus to determine a representation of the scene by determining a zoom factor. In other embodiments, the at least one memory and the computer program code may be further configured to, with the processor, cause the apparatus to determine a representation of the scene by determining a cropping scenario. Furthermore, the at least one memory and the computer program code may be configured to, with the processor, cause the apparatus to determine a representation of the scene based on a physical characteristic of the physical demarcation.

In other embodiments, a method and a computer program product are described for providing a physical demarcation to a user of a device; providing for detection of a position of the user with respect to the device; and determining a representation of a scene capturable via the device. The representation may be determined based on the position detected, and the representation determined may correspond to the user's view of the scene with respect to the physical demarcation.

The physical demarcation may comprise a frame through which the scene is viewable, and/or the physical demarcation may be provided via a display of the device. In some cases, providing for detection of the position of the user with respect to the device may comprise determining a proximity of the user to the device and/or determining an angle of the user with respect to the device. Additionally or alternatively, determining a representation of the scene may comprise determining a zoom factor and/or determining a cropping scenario. Moreover, a representation of the scene may be determined based on a physical characteristic of the physical demarcation.

In still other embodiments, an apparatus is described for providing proximity-based zoom functionality. The apparatus may include means for providing a physical demarcation to a user of a device; means for providing for detection of a position of the user with respect to the device; and means for determining a representation of a scene capturable via the device. The representation may be determined based on the position detected, and the representation determined may correspond to the user's view of the scene with respect to the physical demarcation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a conventional mobile device with image capturing functionality;

FIG. 2 illustrates one example of a communication system according to an example embodiment of the present invention;

FIG. 3 illustrates a schematic block diagram of an apparatus for providing proximity-based zoom functionality according to an example embodiment of the present invention;

FIG. 4 illustrates an apparatus in which the physical demarcation is a reticle according to an example embodiment of the present invention;

FIG. 5 illustrates an apparatus in which the physical demarcation is a reference indication in the form of a pair of protrusions according to an example embodiment of the present invention;

FIG. 6 illustrates an apparatus in which the physical demarcation is a reference indication in the form of a marking according to an example embodiment of the present invention;

FIG. 7 illustrates a user capturing an image of a scene using the device of FIG. 4 according to an example embodiment of the present invention;

FIG. 8A illustrates a representation of a scene as a result of the physical demarcation having been moved toward the user according to an example embodiment of the present invention;

FIG. 8B illustrates a representation of a scene as a result of the physical demarcation having been moved away from the user according to an example embodiment of the present invention; and

FIG. 9 illustrates a flowchart of a method of providing proximity-based zoom functionality according to another example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

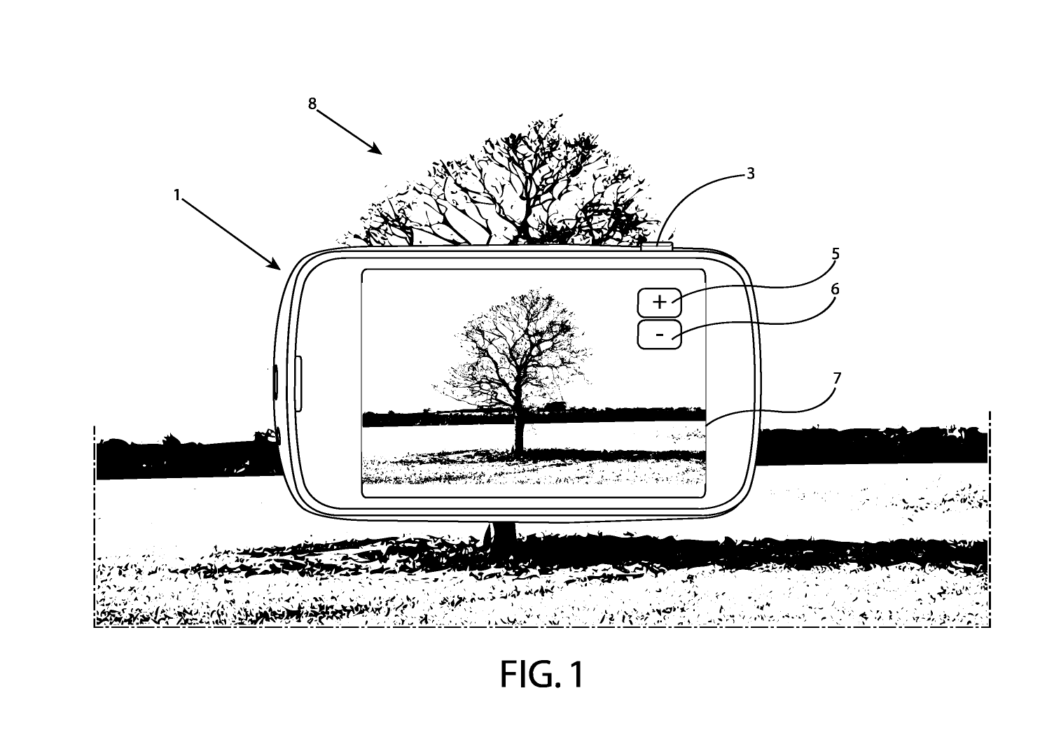

As noted above, many modern mobile devices are equipped with image capturing functionality, such as cameras for capturing still photographs and videos. With reference to FIG. 1, for example, in a conventional device 1, a user can execute operations by pressing buttons, which may be physical buttons 3 provided on the device or virtual buttons 5, 6 provided on a touch display 7. A zoom operation (e.g., “zooming in” and “zooming out”) may, for example, be executed when the user touches a zoom in virtual button 5 (indicated as “+” in the figure) or a zoom out virtual button 6 (indicated as “−” in the figure) provided on the display 7. As a particular zoom button 5, 6 is depressed to indicate a direction of zoom (e.g., zoom in), the device 1 is caused to incrementally adjust the level of zoom on the scene 8 that is the subject of the image capturing operation. The user may view the resulting zoom-adjusted scene as it is being adjusted through the display 7 and may release the zoom button 5 once the desired amount of zoom has been achieved.

Adjusting the zoom in such a manner can be time consuming as the user must wait for the device to incrementally achieve the desired level of zoom as he or she monitors the progress of the zoom operation through the display. Thus, the user must await some sort of visual indication of zoom from the device, and there may be a time-lag associated with this zoom level indication.

In addition, the user must be familiar with the device so as to have a sense of the effect a certain zoom operation will have (e.g., what the captured image will look like as compared to the real scene). For example, the user may want to capture an image such that a certain portion of the scene before him (e.g., the face of a person in the foreground) fills up most of the image area. If the user is unfamiliar with the device, the user may not know how much zooming would be required to achieve this size and may need to resort to trial and mot

Moreover, in order to execute the zoom operation, such as by touching the appropriate buttons 5, 6 to adjust the level of zoom, and then capture the image by depressing another button (e.g., physical button 3), the user's attention may be distracted from other activities that are necessary for capturing a quality image, such as aligning the camera with the scene, evaluating the focus and lighting on the scene, etc. The user may unintentionally shake the device, upset the alignment of the device, affect the focus, or miss a time window of interest for capturing the image (video or still image) as a result of having his or her attention being diverted to achieve the desired amount of zoom.

Furthermore, in some cases, a user may wish to capture an image without the use of a display. For example, the device may not have a display, the user may wish to leave the display turned off so as to save power, the display may introduce too much light to the environment and adversely affect the image being captured (e.g., in a night scene), the light from the display may attract to much attention, and so on. The user may wish to have some indication of what the captured image will look like as a result of the zoom operation, despite not being able to see the scene via the display, so that the user can appropriately determine the content of the image and the zoom level.

Accordingly, embodiments of the present invention provide a physical demarcation to a user of a device, such as by providing a reticle or a reference indication, by which the user can intuitively adjust a level of zoom to be applied in capturing an image. In particular, embodiments of the invention further provide for detection of a position of the user with respect to the device and determine a representation of a scene capturable via the device, where the representation is determined based on the position detected and corresponds to the user's view of the scene with respect to the physical demarcation, as described in greater detail below.

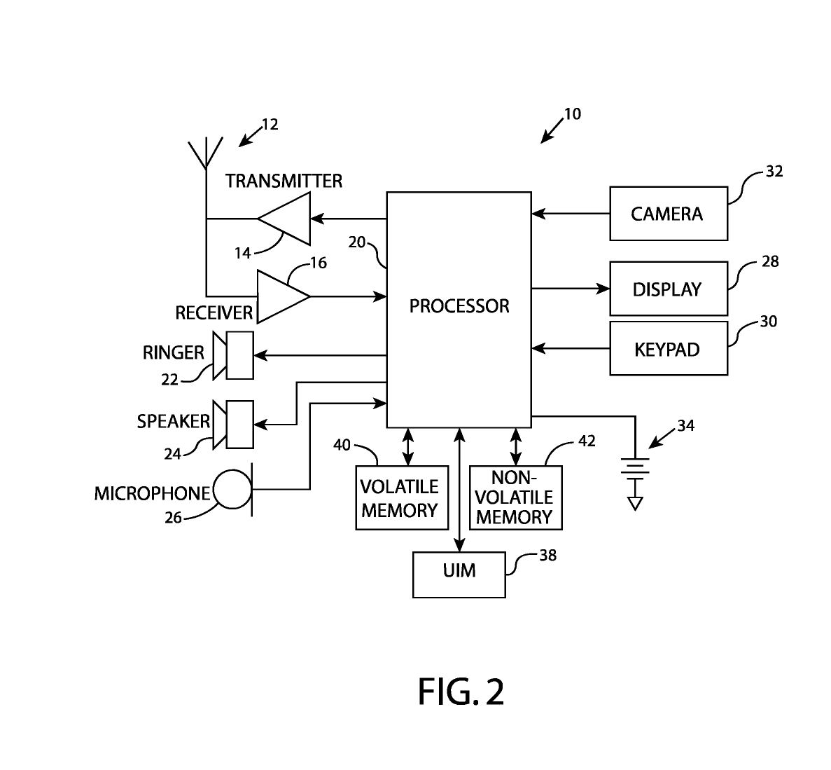

FIG. 2, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

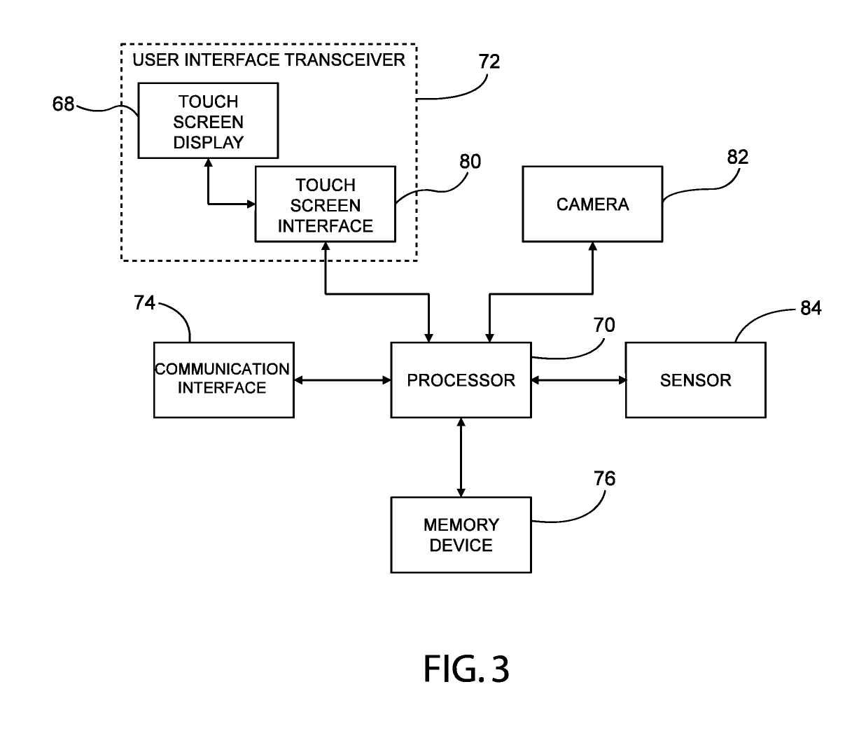

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 3), which controls the provision of signals to and the receipt of signals from the transmitter 14 and receiver 16, respectively. The signals may include a proximity component and/or an orientation component, as described below. The signals may further include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to encode message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element 32 in order to capture images or video of objects, people, and places proximate to the user of the mobile terminal 10. The mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 3, which depicts certain elements of an apparatus 50 for providing proximity-based zoom functionality. The apparatus 50 of FIG. 3 may be employed, for example, in conjunction with the mobile terminal 10 of FIG. 2. However, it should be noted that the apparatus 50 of FIG. 3 may also be employed in connection with a variety of other devices, both mobile and fixed, and therefore, embodiments of the present invention should not be limited to application on devices such as the mobile terminal 10 of FIG. 2. For example, the apparatus 50 may be employed on a personal computer, a tablet, a mobile telephone, or other user terminal. Moreover, in some cases, the apparatus 50 may be on a fixed device such as a server or other service platform, and the content may be presented (e.g., via a server/client relationship) on a remote device such as a user terminal (e.g., the mobile terminal 10) based on processing that occurs at the fixed device.

It should also be noted that while FIG. 3 illustrates one example of a configuration of an apparatus for providing proximity-based zoom functionality, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

Referring now to FIG. 3, the apparatus 50 for providing proximity-based zoom functionality may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard-coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive touch inputs at the touch screen display 68 and to analyze and/or modify a response to such indications based on corresponding user actions that may be inferred or otherwise determined responsive to the touch inputs.

With continued reference to FIG. 3, in an example embodiment, the apparatus 50 may include a touch screen interface 80. The touch screen interface 80 may, in some instances, be a portion of the user interface transceiver 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an input in the form of a touch event at the touch screen display 68. As such, the touch screen interface 80 may be in communication with the touch screen display 68 to receive user inputs at the touch screen display 68 and to modify a response to such inputs based on corresponding user actions that may be inferred or otherwise determined responsive to the inputs. Following recognition of a touch event, the touch screen interface 80 may be configured to determine a classification of the touch event and provide a corresponding function based on the touch event in some situations.

In some example embodiments, the apparatus 50 may include an image capturing element, such as a camera 82, video, and/or audio module, in communication with the processor 70. The image capturing element may be any means for capturing an image, video and/or audio for storage, display, or transmission. For example, in an example embodiment in which the image capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image. Alternatively, the camera may include only the hardware needed to view an image, while a memory device 76 of the apparatus stores instructions for execution by the processor in the form of software necessary to create a digital image file from a captured image. In an example embodiment, the camera 82 may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

As shown in FIG. 3, the apparatus 100 may also include one or more sensors 84, such as a location information receiver (e.g., a GPS receiver), an accelerometer, a gyroscope, a compass, or the like, that may be in communication with the processor 70 and may be configured to determine the location of the apparatus and to detect changes in motion and/or orientation of the apparatus. In particular, according to some embodiments, the sensors 84 may include one or more proximity sensors that are configured to detect and/or quantify the proximity of a target, such as a user of the device. For example, the proximity sensor may be configured to emit and detect infrared light so as to calculate the distance and/or relative position of a target (e.g., the user). As another example, the proximity sensor may be able to calculate the distance and/or relative position of the target using ultra-sonic signals. In some embodiments, as described in greater detail below, the detected proximity of the user (e.g., distance and/or relative position) may be used as an input to determine a desired representation of a scene capturable via the device, such as to determine an amount of zoom to be applied in capturing the image and/or to determine how to crop the captured image.

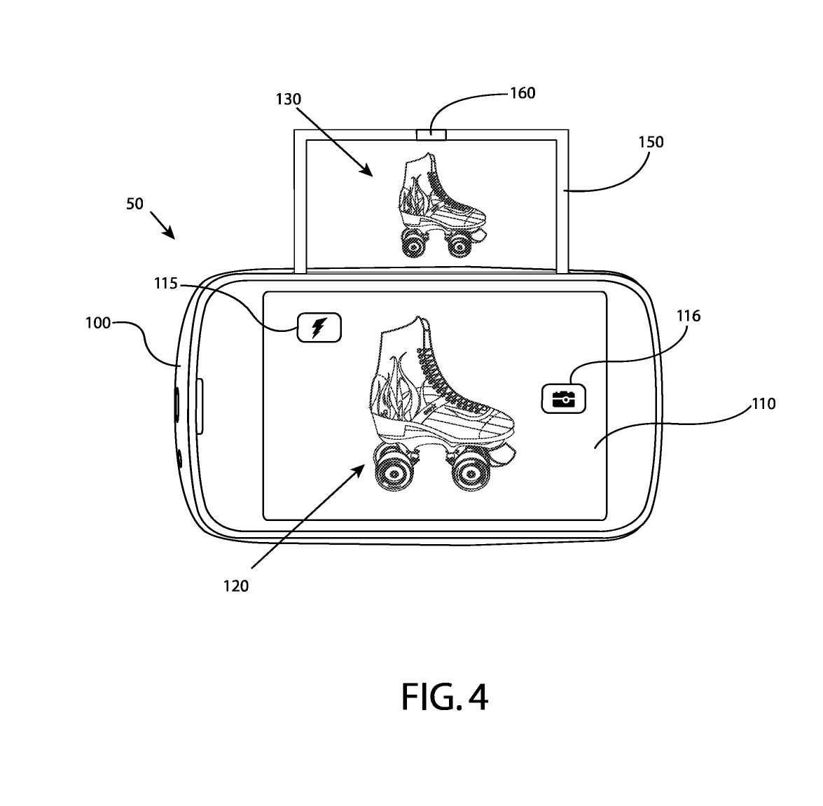

Turning now to FIG. 4, in general, an apparatus 50, such as an apparatus embodied by a device 100 such as the mobile terminal 10 of FIG. 2 (e.g., a cell phone), is provided that includes camera functionality. The device 100 may, for example, include a touch screen display 110 that is configured to allow the user to provide inputs via virtual buttons 115, 116 and/or to present to the user a representation 120 of a scene 130 that is capturable via the device. For example, when in a camera mode, virtual buttons 115, 116 may be presented on the display 110 that allow the user to turn a flash of the camera on and off and/or to capture the image (e.g., to take the picture). In the depicted embodiment, the scene 130 is a potted flower, and a representation 120 of the scene is presented on the display 110 to provide a preview to the user of what the captured image will look like. As such, the boundary 140 of the display 110 may be thought of as the physical boundary (e.g., the edges) of a hard copy photograph in the example of a still image or as the edges of a video screen in the example of a video.

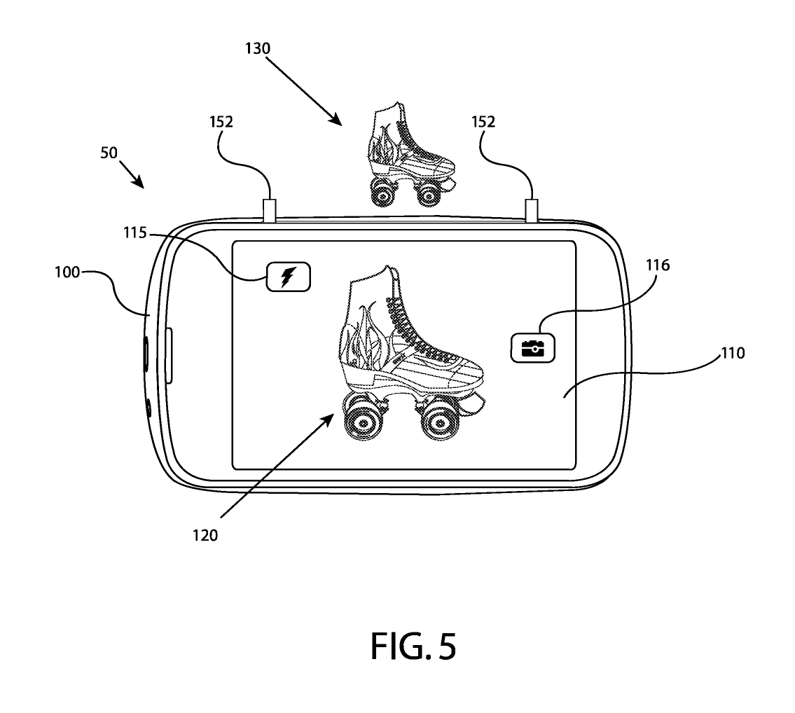

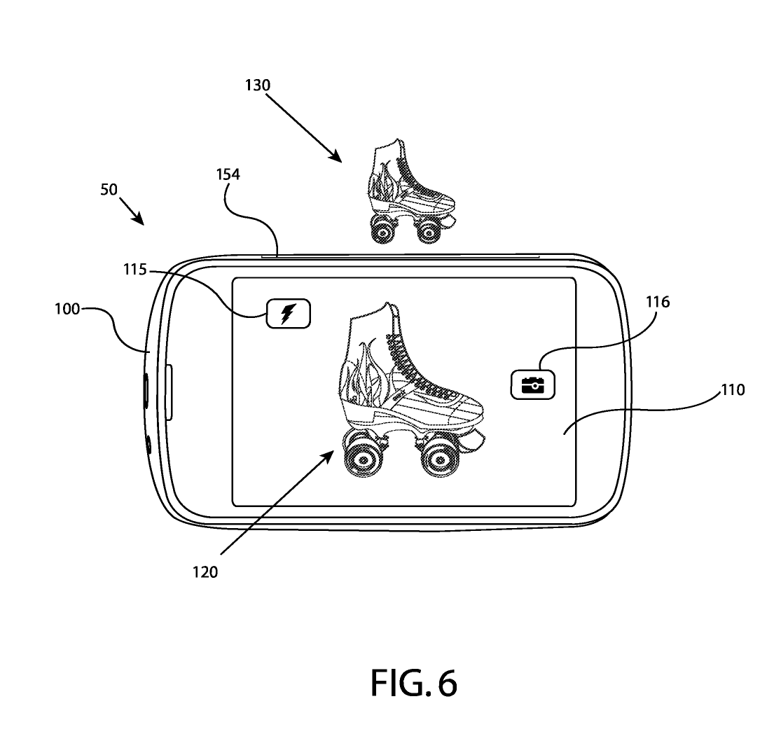

As described above, the apparatus 50 may comprise at least one processor (e.g., processor 70 of FIG. 3) and at least one memory (e.g., memory device 76 of FIG. 3) including computer program code. The at least one memory and the computer program code may be configured to, with the processor, cause the apparatus 50 to at least provide a physical demarcation to a user of the device 100. In some embodiments, the physical demarcation may comprise a frame through which the scene 130 is viewable. The frame may, for example, comprise a reticle 150 having a number of sides (e.g., four sides) that provide an enclosed view of the scene 130 to be captured. In still other embodiments, the physical demarcation may be a reference indication provided on the device 100 indicating a dimension along a single axis, such as a protrusion or pair of protrusions 152 (shown in FIG. 5) or a marking 154 (shown in FIG. 6) that indicates a width of the representation of the captured image. In this way, a span of the captured image may correspond to the user's view of the scene with respect to the reference indication. The physical demarcation may, in some cases be mounted on or otherwise supported by the device 100, as shown in the depicted examples of FIGS. 4-6. In other cases, however, the physical demarcation may be physically separate from the device 100, such as a stand-alone reticle.

In still other embodiments, the physical demarcation may be provided via the display 110. For example, one or more of the edges 112 of the display 110 may serve as the reference indication to the user (e.g., the top edge of the display may serve as a reference indication indicating a span of the captured image, as described above). As another example, the captured image may correspond to what the user would view through the display 110 if the display were a pass through display.

In some cases, a particular device 100 may be configured to work with more than one physical demarcation, and a user may be able to select a particular physical demarcation to use for capturing an image. For example, multiple reticles (e.g., reticles having different sizes) may be used, and a user may be able to switch between the different available reticles. In one example, a device 100 having a display 110 may have a separate, stand-alone reticle, and the user may be able to use the display as the physical demarcation in one instance (e.g., when the display is enabled) and may be able to use the separate reticle as the physical demarcation in another instance (e.g., when the display is disabled). The user may, in some cases, configure the dynamic selection of the physical demarcation, such as by adjusting user settings on the device 100.

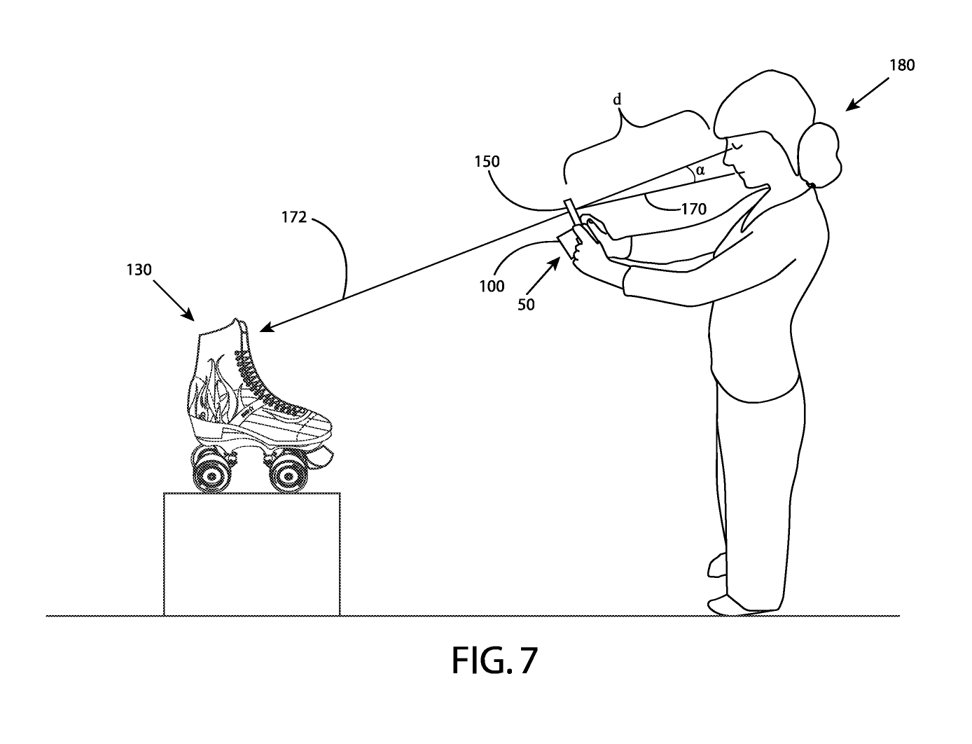

Turning now to FIG. 7, the at least one memory and the computer program code may be further configured to, with the processor, cause the apparatus 50 to provide for detection of a position of the user 180 with respect to the device 100. For example, a proximity sensor 160 (such as the sensor 84 of FIG. 3) may be provided on the reticle 150, as shown in FIG. 4, that is configured to determine a proximity of the user 180 to the device 100. The proximity sensor 160 may, however, be located somewhere other than the reticle 150, such as on the device 100 itself, on an attachment to the device, or anywhere else that would allow for determination of user proximity The sensor 160 may, in some cases, be configured to emit signals (such as infrared light) in the direction of the user 180 of the device 100 and detect return signals that are reflected off the user. By analyzing the difference in signal strength between transmitted signals and return signals, such as via the processor 70 of FIG. 3, the apparatus 50 may be able to calculate a distance d of the user 180 to the sensor 160, as illustrated in FIG. 7. In addition or alternatively, in some embodiments, the apparatus 50 may be caused (e.g., via the processor) to determine an angle a of the user 180 with respect to the device 100. For example, the angle a may be determined as the angle between a line 170 perpendicular to the plane of the reticle 150 and a viewing line 172 of the user 180 through the reticle. The angle a may be determined with respect to other axes, as well, such as with respect to an axis aligned with the user's body so as to determine a left-right bias of the user's view of the scene.

Thus, in some embodiments, the at least one memory and the computer program code may be further configured to, with the processor, cause the apparatus 50 to determine a representation of a scene capturable via the device, where the representation is determined based on the position detected and wherein the representation determined corresponds to the user's view of the scene with respect to the physical demarcation. For example, the at least one memory and the computer program code may be configured to, with the processor, cause the apparatus 50 to determine a representation of the scene by determining a zoom factor. In other words, in some cases, the apparatus may be caused to adjust the level of zoom based on the distance of the user 180 from the physical demarcation (e.g., the reticle 150 in FIG. 7). Alternatively or additionally, the at least one memory and the computer program code may be configured to, with the processor, cause the apparatus 50 to determine a representation of the scene by determining a cropping scenario. In this way, the apparatus may be caused to provide an image that corresponds to the viewing area seen by the user through the reticle in this example.

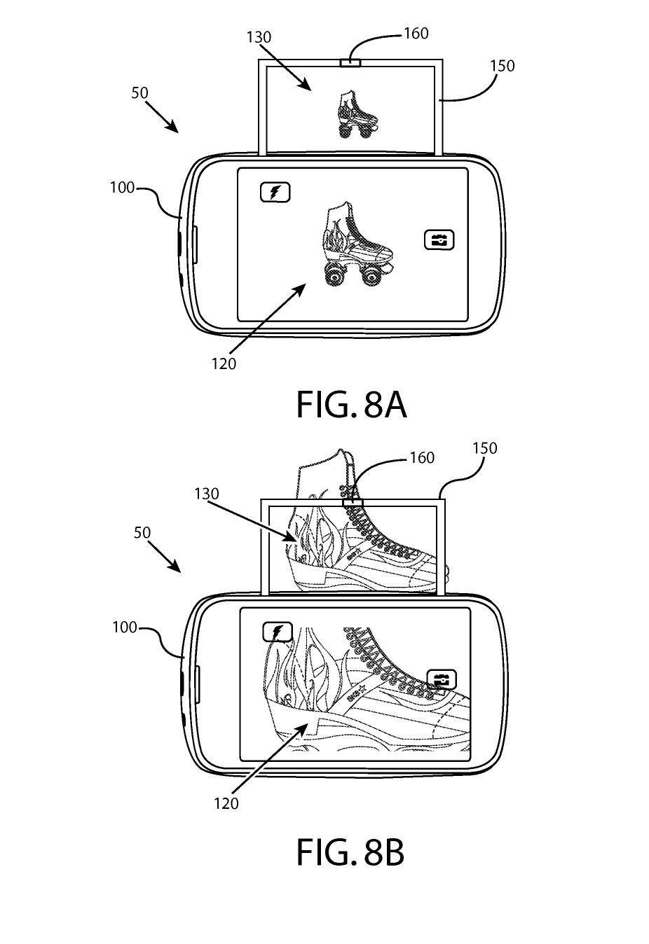

Accordingly, in some embodiments, as the reticle 150 is moved closer to the user 180 (e.g., the distance d decreases), the scene that is viewable through the reticle may be reduced in size such that more of the scene is captured in the representation (e.g., corresponding to a larger area of the scene being viewable through the reticle). An example scene viewable through the reticle 150 of FIG. 7 as the reticle is moved closer to the user 180 (smaller distance d) is shown in FIG. 8A. Conversely, as the reticle 150 is moved away from the user 180 (e.g., the distance d increases), the scene that is viewable through the reticle may be enlarged in size such that less of the scene is captured in the representation (e.g., corresponding to a smaller area of the scene being viewable through the reticle). An example scene viewable through the reticle 150 of FIG. 7 as the reticle is moved farther away from the user 180 (larger distance d) is shown in FIG. 8B. Similarly, turning again to FIG. 7, as the angle a is changed by the user's movement of the reticle 150, and the resulting scene being viewed through the reticle is shifted, the representation of the scene capturable via the device may also be adjusted (e.g., shifted and/or enlarged or reduced) to correspond to the user's view.

The representation 120 may be made to correspond with the user's view with respect to the physical demarcation (e.g., through the reticle) by determining and applying a zoom factor to the scene 130 to be captured, such as through lens adjustment prior to capturing the image. In some cases, however, the image may be captured at the full resolution of the camera and then cropped and/or scaled digitally to correspond to the user's view through the reticle. The cropping scenario, in this example, may correspond to how much of the captured image (e.g., along the sides of the captured image) should be removed and/or how the captured image should be scaled to fit a certain area designated for the representation (corresponding, for example, to the finished dimensions of the desired captured image, such as the size of a photograph).

In some embodiments, the at least one memory and the computer program code may be configured to, with the processor, cause the apparatus 50 to determine a representation of the scene based on a physical characteristic of the physical demarcation. In particular, in some cases, the zoom factor to be applied based on the proximity determined may be based on the size of the physical demarcation. For example, at a specific proximity of the user, a relatively larger reticle may be associated with a different zoom factor than a relatively smaller reticle. The zoom factor may be based on predetermined information, calibration information, camera optics, camera sensor information, and/or a combination of these, among other things.

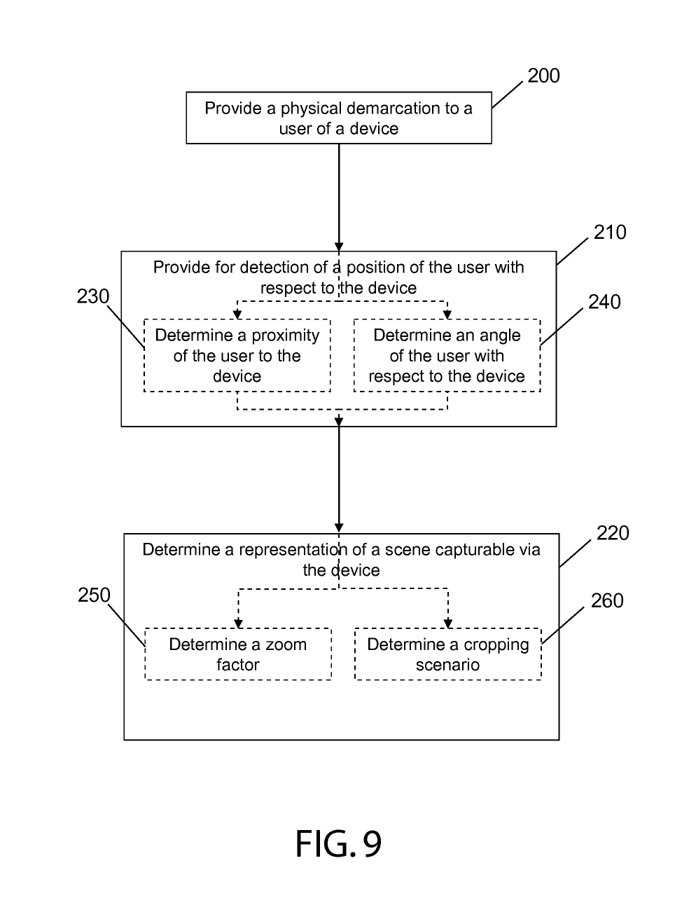

FIG. 9 illustrates flowcharts of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowcharts support combinations of means for performing the specified functions, combinations of operations for performing the specified functions, and program instruction means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In this regard, one embodiment of a method for providing proximity-based zoom functionality for image capturing operations, as shown in FIG. 9, includes providing a physical demarcation to a user of a device at Block 200, providing for detection of a position of the user with respect to the device at Block 210, and determining a representation of a scene capturable via the device at Block 220. The representation may be determined based on the position detected and may correspond to the user's view of the scene with respect to the physical demarcation. The physical demarcation may comprise a frame through which the scene is viewable. Additionally or alternatively, the physical demarcation may be provided via a display of the device.

Providing for detection of a position of the user with respect to the device may include determining a proximity of the user to the device at Block 230 and/or determining an angle of the user with respect to the device at Block 240, as described in greater detail above with reference to the figures. In some cases, determining a representation of the scene may comprise determining a zoom factor at Block 250, whereas in other cases determining a representation of the scene may comprise determining a cropping scenario at Block 260. Moreover, in some embodiments, the determination of the representation of the scene may be based on a physical characteristic of the physical demarcation.

In some embodiments, certain ones of the operations above may be modified or further amplified as described below. Furthermore, in some embodiments, additional optional operations may be included, some examples of which are shown in dashed lines in FIG. 9. Modifications, additions, or amplifications to the operations above may be performed in any order and in any combination.

In an example embodiment, an apparatus for performing the method of FIG. 9 above may comprise a processor (e.g., the processor 70 of FIG. 3) configured to perform some or each of the operations (200-250) described above. The processor may, for example, be configured to perform the operations (200-250) by performing hardware implemented logical functions, executing stored instructions, or executing algorithms for performing each of the operations. Alternatively, the apparatus may comprise means for performing each of the operations described above. In this regard, according to an example embodiment, examples of means for performing at least portions of operation 200 may comprise, for example, the user interface transceiver 72, the processor 70, the memory device 76, and/or a device or circuit for executing instructions or executing an algorithm for processing information as described above. Examples of means for performing operations 210, 230, and 240 may comprise, for example, the processor 70, the memory device 76, the sensor 84, and/or a device or circuit for executing instructions or executing an algorithm for processing information as described above. Examples of means for performing operations 220, 250, and 260 may comprise, for example, the processor 70, the memory device 76, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
provide a physical demarcation to a user of a device;
provide for detection of a position of the user with respect to the device; and
determine a representation of a scene capturable via the device, wherein the representation is determined based on the position detected, and wherein the representation determined corresponds to the user's view of the scene with respect to the physical demarcation.

2. The apparatus of claim 1, wherein the physical demarcation comprises a frame through which the scene is viewable.

3. The apparatus of claim 1, wherein the physical demarcation is provided via a display of the device.

4. The apparatus of claim 1, wherein the at least one memory and the computer program code are further configured to, with the processor, cause the apparatus to provide for detection of the position of the user with respect to the device by determining a proximity of the user to the device.

5. The apparatus of claim 1, wherein the at least one memory and the computer program code are further configured to, with the processor, cause the apparatus to provide for detection of the position of the user with respect to the device by determining an angle of the user with respect to the device.

6. The apparatus of claim 1, wherein the at least one memory and the computer program code are further configured to, with the processor, cause the apparatus to determine a representation of the scene by determining a zoom factor.

7. The apparatus of claim 1, wherein the at least one memory and the computer program code are further configured to, with the processor, cause the apparatus to determine a representation of the scene by determining a cropping scenario.

8. The apparatus of claim 1, wherein the at least one memory and the computer program code are further configured to, with the processor, cause the apparatus to determine a representation of the scene based on a physical characteristic of the physical demarcation.

9. A method comprising:
providing a physical demarcation to a user of a device;
providing for detection of a position of the user with respect to the device; and
determining, via a processor, a representation of a scene capturable via the device, wherein the representation is determined based on the position detected, and wherein the representation determined corresponds to the user's view of the scene with respect to the physical demarcation.

10. The method of claim 9, wherein the physical demarcation comprises a frame through which the scene is viewable.

11. The method of claim 9, wherein providing for detection of the position of the user with respect to the device comprises determining a proximity of the user to the device.

12. The method of claim 9, wherein providing for detection of the position of the user with respect to the device comprises determining an angle of the user with respect to the device.

13. The method of claim 9, wherein determining a representation of the scene comprises determining a zoom factor.

14. The method of claim 9, wherein determining a representation of the scene comprises determining a cropping scenario.

15. A computer program product comprising at least one non-transitory computer-readable storage medium having computer-executable program code portions stored therein, the computer-executable program code portions comprising program code instructions for:
providing a physical demarcation to a user of a device;
providing for detection of a position of the user with respect to the device; and
determining a representation of a scene capturable via the device, wherein the representation is determined based on the position detected, and wherein the representation determined corresponds to the user's view of the scene with respect to the physical demarcation.

16. The computer program product of claim 15, wherein the physical demarcation comprises a frame through which the scene is viewable.

17. The computer program product of claim 15, wherein the program code instructions configured for providing for detection of the position of the user with respect to the device are further configured for determining a proximity of the user to the device.

18. The computer program product of claim 15, wherein the program code instructions configured for providing for detection of the position of the user with respect to the device are further configured for determining an angle of the user with respect to the device.

19. The computer program product of claim 15, wherein the program code instructions configured for determining a representation of the scene are further configured for determining a zoom factor.

20. The computer program product of claim 15, wherein the program code instructions configured for determining a representation of the scene are further configured for determining a cropping scenario.
